(19) United States
(12) Patent Application Publication
(10) Pub. No.: US 2026/0138304 A1
(43) Pub. Date: May 21, 2026

(54) MOLD FOR CONCRETE FORMWORK MODULE AND ASSEMBLY THEREOF, CONCRETE FORMWORK MODULE AND SECTION AND METHOD OF MANUFACTURING AND INSTALLATION THEREOF

(71) Applicant: 9325-1692 QUEBEC INC., Granby (CA)

(72) Inventors: Alain Brouillard, Granby, QC (CA); Luc Williams, Granby, QC (CA)

(21) Appl. No.: 19/120,264

(22) PCT Filed: Oct. 12, 2023
(86) PCT No.: PCT/CA2023/051355

§ 371 Date: Apr. 11, 2025

Related U.S. Application Data
(60) Provisional application No. 63/379,163, filed on Oct. 12, 2022.

(51) Int. Cl. B28B 7/00; B28B 23/02

(52) U.S. Cl. CPC B28B 7/0044; B28B 23/028

(57) ABSTRACT

Typical prefabricated concrete formworks for buildings and structures generally require significant space, time and manpower to properly install. The present invention provides a mold, mold assembly and method for quickly manufacturing concrete formwork modules requiring reduced manpower, space and time to install. The concrete formwork mold assembly comprises a bottom section and at least two top sections for reducing operational downtime. A concrete formwork module and section are also provided, the modules comprising at least three layers: a first and fourth of architectural concrete, a third of air to be filled by reinforced concrete, and possibly a second of insulation. Connecting rods with reduced thermal bridges and fluid evacuating slits are provided. A method of installing the concrete formwork modules to form a section is also provided, the method comprising aligning the modules with aligning means.

### CROSS-REFERENCE TO RELATED APPLICATIONS

There are no cross-related applications.

### FIELD OF THE INVENTION

The present invention generally relates to molds for concrete formworks, the concrete formwork modules and the manufacturing and installation methods thereof.

### BACKGROUND OF THE INVENTION

Insulated concrete formworks are gaining popularity in construction of buildings due to a plurality of advantages compared to traditional construction methods. Amongst others, superior insulation and rigidity of the concrete structure are some of those advantages. Once the concrete formworks are placed, layers of finish surfaces must be drilled in plates found in the formworks to obtain aesthetically pleasing buildings surfaces. In order to install the finished surfaces, scaffoldings must be installed which requires time, space and money. Moreover, in order to install the formworks, multiple retaining braces for supporting the formworks must be installed before pouring the concrete and uninstalled after.

Furthermore, the manufacturing of insulated concrete formworks generally takes time and specialized equipment and often results in formworks having high variance of dimensions. Hence, either a substantial number of manufactured formworks must be discarded or the resulting building will have uneven walls.

There is thus a need for a mold allowing fast and precise manufacture of concrete formwork modules and of the associated concrete formwork modules to be used in various applications.

### SUMMARY OF THE INVENTION

The shortcomings of the prior art are generally mitigated by providing a mold for manufacturing insulated concrete formwork modules, a concrete formwork mold assembly, a method of manufacturing a concrete formwork module using a mold, a concrete formwork module, a concrete formwork section, and a method of installing a concrete formwork section in accordance with the above recited embodiments.

Other and further aspects and advantages of the present invention will be obvious upon an understanding of the illustrative embodiments about to be described or will be indicated in the appended claims, and various advantages not referred to herein will occur to one skilled in the art upon employment of the invention in practice.

### BRIEF DESCRIPTION OF THE DRAWINGS

The above and other aspects, features and advantages of the invention will become more readily apparent from the following description, reference being made to the accompanying drawings in which:

FIG. 1 is an illustration of a side elevation view of an embodiment of a concrete formwork module in accordance with the principles of the present application.

FIG. 2 is an illustration of a perspective view of the concrete formwork module of FIG. 1.

FIG. 3 is an illustration of a side elevation view of another embodiment of a concrete formwork module wherein the air layer has been filled with reinforced concrete in accordance with the principles of the present application.

FIG. 4 is an illustration of a perspective view of an embodiment of a concrete formwork section in accordance with the principles of the present invention.

FIG. 5 is an illustration of a perspective view of an embodiment of a mold assembly in accordance with the principles of the present invention.

FIG. 6 is an illustration of an exploded perspective view of an embodiment of the mold assembly of FIG. 5.

FIG. 7 is an illustration of a perspective view of an embodiment of a top mold section in accordance with the principles of the present invention.

FIG. 8 is an illustration of a perspective view of another embodiment of a top mold section in accordance with the principles of the present invention, showing the metal sheet layering with the surface of the top section.

FIG. 9 is an illustration of a side view of an embodiment of a top mold section in accordance with the principles of the present invention.

FIG. 10 is an illustration of a side view of an embodiment of a bottom mold section in accordance with the principles of the present invention.

FIG. 11 is an illustration of a perspective view of an embodiment of a bottom mold section in accordance with the principles of the present invention.

FIG. 12 is an illustration of a perspective view of another embodiment of a top mold section in accordance with the principles of the present invention, showing the metal sheet layering with the surface of the top section.

FIG. 13 is an illustration of a perspective view of an embodiment of a top or bottom mold section in accordance with the principles of the present invention, showcasing the mold without its side doors.

FIG. 14 is an illustration of a side view of an embodiment of a mold assembly in accordance with the principles of the present invention.

FIG. 15 is an illustration of a detailed side view of an upwardly extending extension of the top mold section in accordance with the principles of the present invention.

FIG. 16 is an illustration of a detailed profile view of an upwardly extending extension of the top mold section in accordance with the principles of the present invention.

FIG. 17 is an illustration of a detailed perspective view of an upwardly extending extension of the top mold section in accordance with the principles of the present invention.

FIG. 18 is an illustration of a detailed view of the edge and hinges of the top and bottom mold sections according to the principles of the present invention.

FIG. 19 is an illustration of a detailed view of the top mold section according to the principles of the present invention, showcasing the guiding plate.

FIG. 20 is another illustration of a detailed view of the top mold section according to the principles of the present invention, showcasing the guiding plate.

FIG. 21 is an illustration of a detailed view of an embodiment of a concrete formwork section comprising fastening holes in accordance with the principles of the present invention.

FIG. 22 is an illustration of a detailed view of another embodiment of a concrete formwork section comprising fastening holes and fasteners in accordance with the principles of the present invention.

FIG. 23 is an illustration of a concrete framework mold assembly comprising three sections, in accordance with the principles of the present invention.

### DETAILED DESCRIPTION OF THE INVENTION

A novel MOLD FOR CONCRETE FORMWORK MODULE AND ASSEMBLY THEREOF, CONCRETE FORMWORK MODULE AND SECTION AND METHOD OF MANUFACTURING AND INSTALLATION THEREOF will be described hereinafter. Although the invention is described in terms of specific illustrative embodiments, it is to be understood that the embodiments described herein are by way of example only and that the scope of the invention is not intended to be limited thereby. For illustrative purposes only, the concrete formwork modules and sections below described will be embodied as configured to form walls of a building. It may however be understood that any other structures such as floors, pillars, retaining walls, foundations, interior dividing walls, and the like may make use of the concrete formwork modules that can be realized according to the present invention.

Moreover, certain terminology is used in the following description for convenience only and is not intended to be limiting. For purposes of this description, the terms “vertical” and “horizontal” are merely illustrative of relative space positions of the various components in the drawings. In actual practice, it is apparent that the components can be aligned in either orientation. Moreover, the terms “upper”, “middle”, “lower”, “front”, “rear”, “left”, “right”, “inner”, “outer” or any synonymous variation thereof designate directions in the embodiments of the drawings to which reference is made.

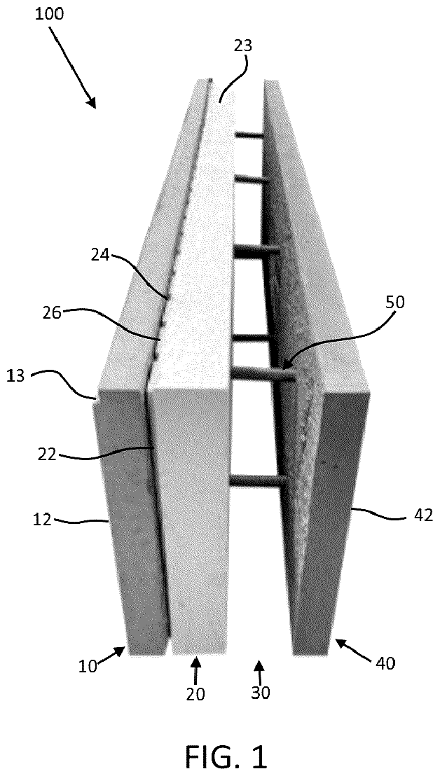

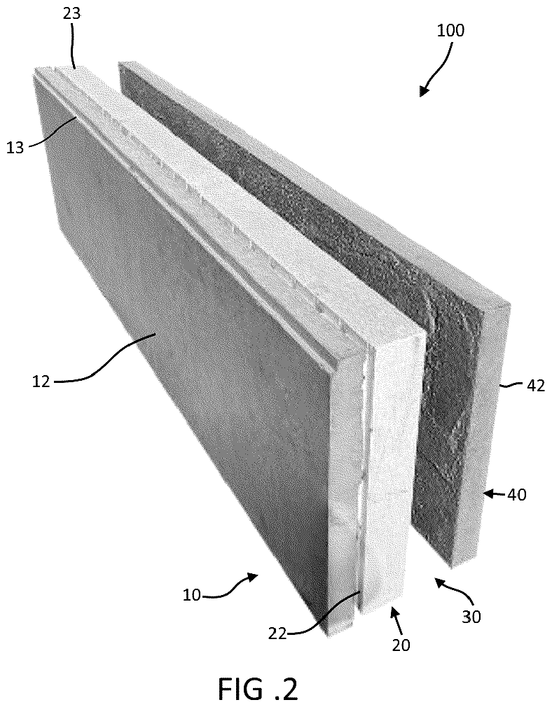

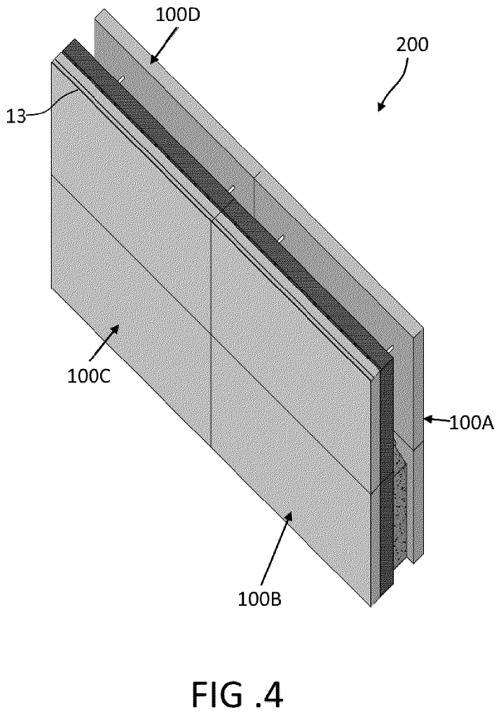

FIGS. 1 and 2 are showing a first embodiment of a concrete formwork module 100. The concrete formwork module 100 is comprised of four layers. A first layer 10 and a fourth layer 40 being layers of concrete disposed at opposite ends of the module 100 and inbetween are a second layer 20 being an insulating layer and a third layer 30 being an air layer. The concrete formwork module 100 may be assembled with other concrete formwork modules disposed over, under and/or on the left and right sides of the module 100 to form a concrete formwork wall section 200 shown in FIG. 4. The wall section 200 may be adjacent to the outside of a building or structure or it may be adjacent to the inside, such as rooms, of the building or structure only. Understandably, the concrete formwork module 100 is generally used in between the outside and the inside of a building or structure given the insulating and structural properties it comprises.

In certain embodiments, the concrete formwork module 100 may only comprise three layers: two architectural concrete layers (10, 40) and a middle layer 30. In these embodiments, there is no insulating layer 20 and the middle layer 30 may be a layer of air configured to be filled with reinforcing concrete once the concrete formwork module 100 is positioned for use. Understandably, the concrete formwork module 100 having no insulating layer 20 may be used in dividing walls of a buildings, in retaining walls, and in other known applications requiring no substantial insulation.

Any of the first layer 10 or fourth layer 40 concrete layers may be configured to be facing the inside of a building, construction or structure and the other concrete layer (10 or 40) may be configured to be facing the outside of the building. Alternatively, the two concrete layers (10, 40) may be configured to face indoors of a building, for example if they are part of a wall section separating two rooms of the building. Because the first 10 and fourth 40 concrete layers may face inside or outside a building and therefore be seen by people, the outward surfaces (12, 42) may have a finished surface having a decorative aspect. For example, the outward surfaces may have the aspect of a traditional wall of bricks, rocks, wood planks, or any other traditional building wall finish. The color and shine of the outward surfaces may also be varied to obtain different finish aspects. The finished surfaces (12, 42) may also simply be a flat surface.

The insulating layer 20 is disposed between the first concrete layer 10 and the air layer 30. The insulating layer 20 is configured to minimize displacement of heat and/or noise through the concrete formwork module 100. The insulating layer 20 may further act as a flame-retardant barrier. The insulating layer 20 may be rigid foam. In an embodiment of the invention, the insulating layer is polystyrene. In other embodiments, the insulating layer 20 may be any other insulating material known in the art. Slits 24 may be located on the surface 22 of the insulating layer facing the first concrete layer 10. The slits 24 may cover the entire height of the insulating layer 20 in order to allow flowing of fluids, such as air, liquids and humidity from the top of the concrete formwork module 100 towards the bottom of the same. To further guide the flow of fluid toward the slits 24, a drip edge 26, embodied as a downwardly angled surface, may be located on the top surface 23 of the insulating layer 20. The combination of the drip edge 26 and of the slits 24 may therefore help prevent accumulation of fluids on or within the concrete formwork module 100.

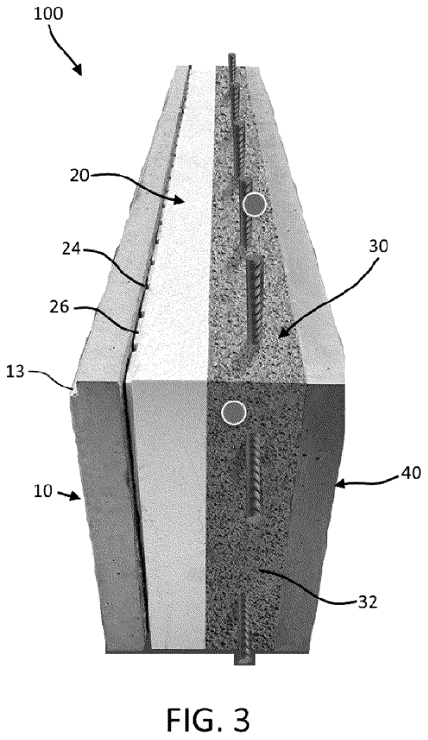

The air layer 30 is disposed between the fourth concrete layer 40 and the insulating layer 20. The air layer 30 is configured to be filled with reinforced concrete 32, as illustrated in FIG. 3, once the concrete formwork module 100 is placed and ready for use as part of a building or structure. Although it may be possible to fill the air layer 30 with other types of concrete, filling the air layer with reinforced concrete 32 may provide substantial structural stability to the concrete formwork module 100 and is therefore preferred. Filling of the air layer 30 with reinforced concrete 32 once the concrete formwork module 100 is located at its permanent or temporary location rather than during manufacturing may allow easier transportation and manipulation of the concrete formwork module due to the significant weight of the poured reinforced concrete and increases its rigidity.

The four layers (10, 20, 30 and 40) are secured to one another by a plurality of connecting rods 50. The connecting rods 50 are configured to substantially immobilize each of the layers (10, 20, 30 and 40) relative to one another. Accordingly, the connecting rods 50 extend from the first concrete layer 10 to the fourth concrete layer 40 and hence throughout the insulating layer 20 and the air layer 30. The embodied connecting rods 50 may secure the positioning of the layers of the concrete formwork module 100 without promoting heat transfer by being made of a heat insulating material. For example, the connecting rods 50 may be made of plastic reinforced with high density fiberglass or carbon fibers to prevent the creation of a thermal bridge often seen in other connecting rods of the prior art usually made of metal. The quantity and positioning of the connecting rods 50 may vary and is not limited to the shown embodiment.

The concrete formwork module 100 is generally rectangular when seen from the front, although it may be understood that the length, width and height of the concrete formwork module 100 and of each of the layers (10, 20, 30 and 40) may have varying dimensions and proportions relative to one another. Hence, the concrete formwork module 100 and its layers (10, 20, 30 and 40) may have varying dimensions based on the characteristics required for its intended use. In another embodiment of the invention, the concrete formwork module 100 may have one or a plurality of angles and/or curvatures on the surfaces of each of the layers (10, 20, 30, 40). For example, the concrete formwork module 100 may comprise a ninety-degree angle to be used as a corner or deviation of the wall of a building or structure. Understandably, any other angle known in the art of formwork modules may be used.

Referring now to FIG. 4, the shown embodiment is a concrete formwork wall section 200 comprising four concrete formwork modules (100A, 100B, 100C and 100D) as above described. The concrete formwork modules (100A, 100B, 100C and 100D) may be stacked on top of one another and placed adjacent to other concrete formwork modules 100. It may be appreciated that when forming a concrete formwork wall section 200, the layers (10, 20, 30 and 40) of each of the concrete formwork modules 100 may be aligned with the same layers of the other modules 100. Accordingly, the air layers 30 of the concrete formwork modules (100A, 100B, 100C and 100D) comprised in a concrete formwork wall section 200 may preferably align with one another so that reinforced concrete 32 may be poured in each vertically stacked modules 100 of a section 200 from the top module 100 only. Furthermore, the slits 24 of the insulating layers 20 of stacked concrete formwork modules 100 may also preferably align with one another to guide fluids from the top of a concrete formwork section 200 towards the bottom of the same.

To increase alignment precision of adjacent concrete formwork modules 100, aligning means 60, not shown, may be located on any of top, bottom or side surfaces of any of the first 10 and fourth 40 concrete layers and of the second insulating layer 20. The aligning means 60 are configured to guide the connection between two adjacent concrete formwork modules 100 so that similar layers of each respective module 100 may substantially align with one another. The aligning means 60 may therefore prevent undesired deviation of the exterior surfaces (12, 42) of a concrete formwork section 200 which may cause structural, thermal and aesthetic problems if unattended. The aligning means 60 may be embodied as rounded protrusions 62 with matching concave cavities 64. A layer side, top or bottom surface may therefore comprise only rounded protrusions 62, only concave cavities 64 or a combination of both. For example, concrete formwork modules 100 of a concrete formwork section 200 may comprise rounded protrusions 62 on the top surface of their respective first 10 and fourth 40 concrete layers and concave cavities 64 on the bottom surface of their respective first 10 and fourth 40 concrete layers. Coincidently, a concrete formwork module 100 stacked on top of another will be precisely aligned due to the rounded protrusions 62 of the bottom module 100 matching with the concave cavities 64 of the top module. It may be understood that the geometry, size, location and quantity of aligning means 60 may vary in other embodiments.

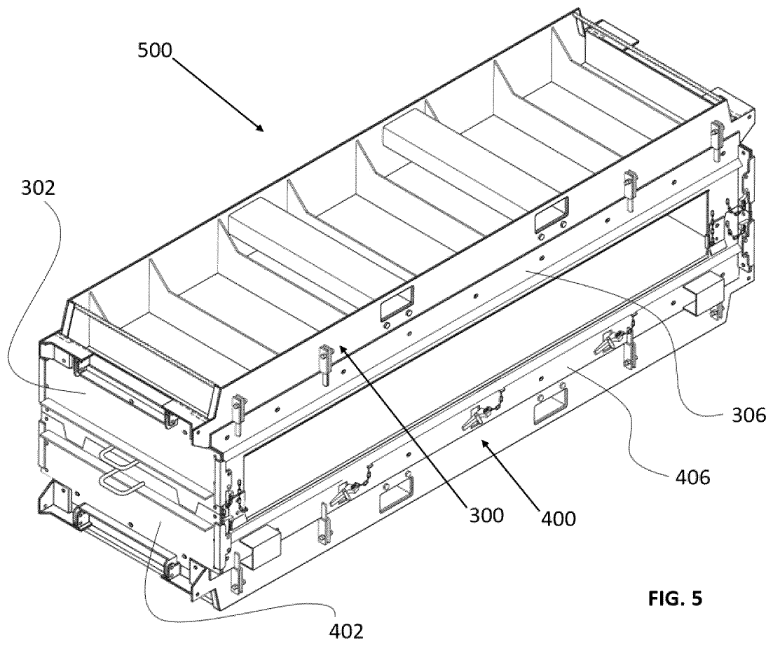

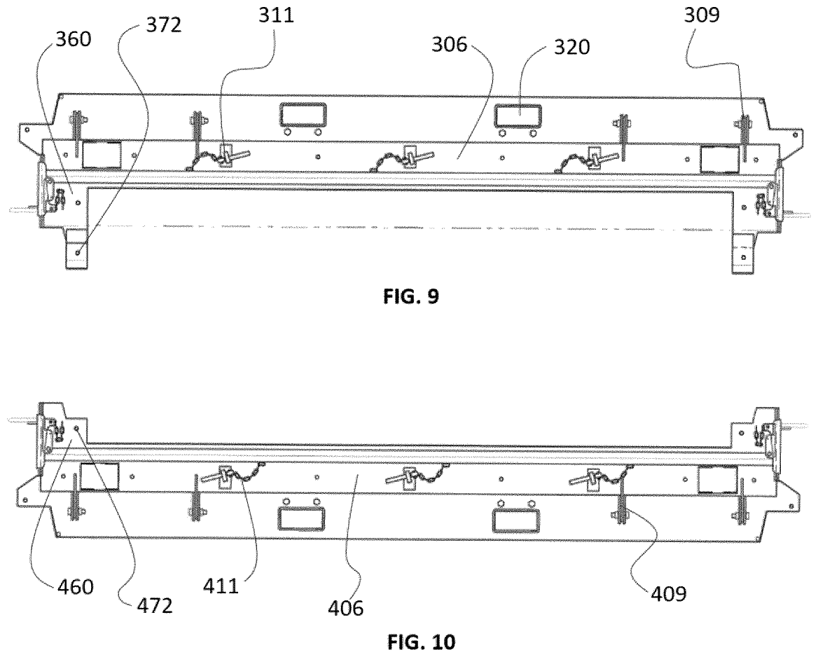

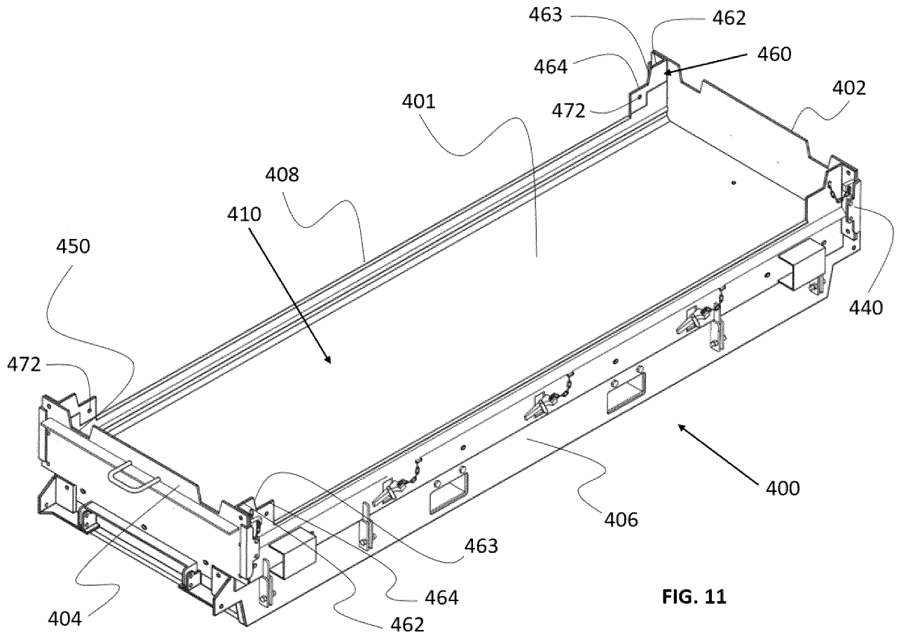

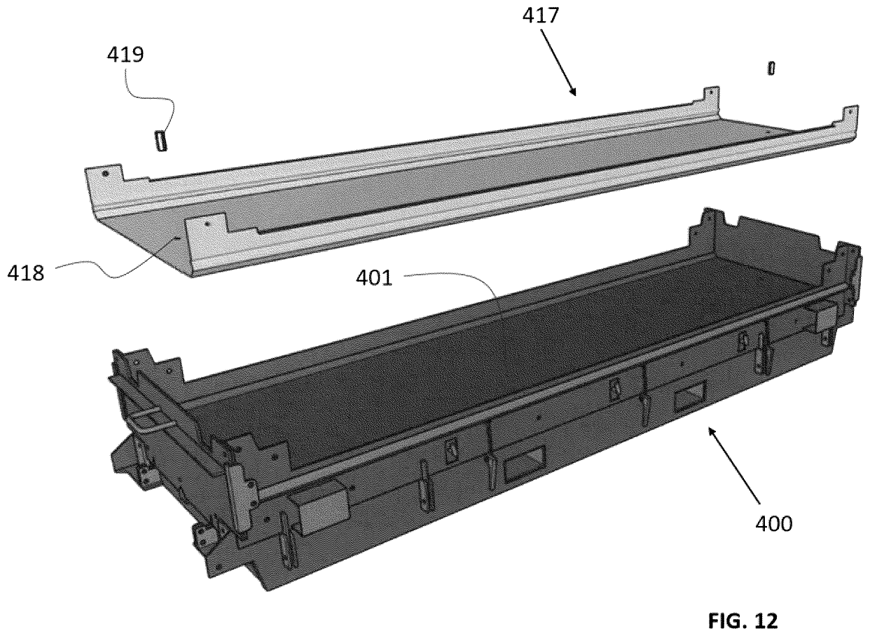

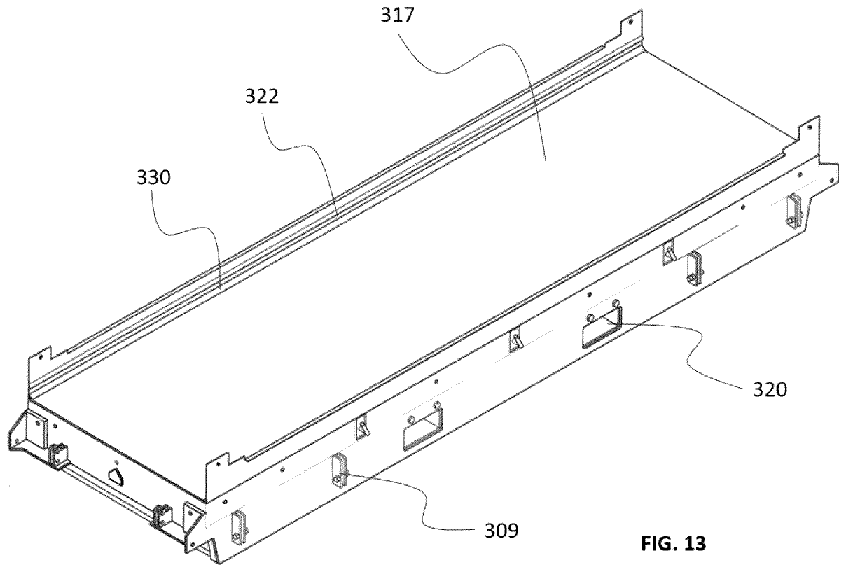

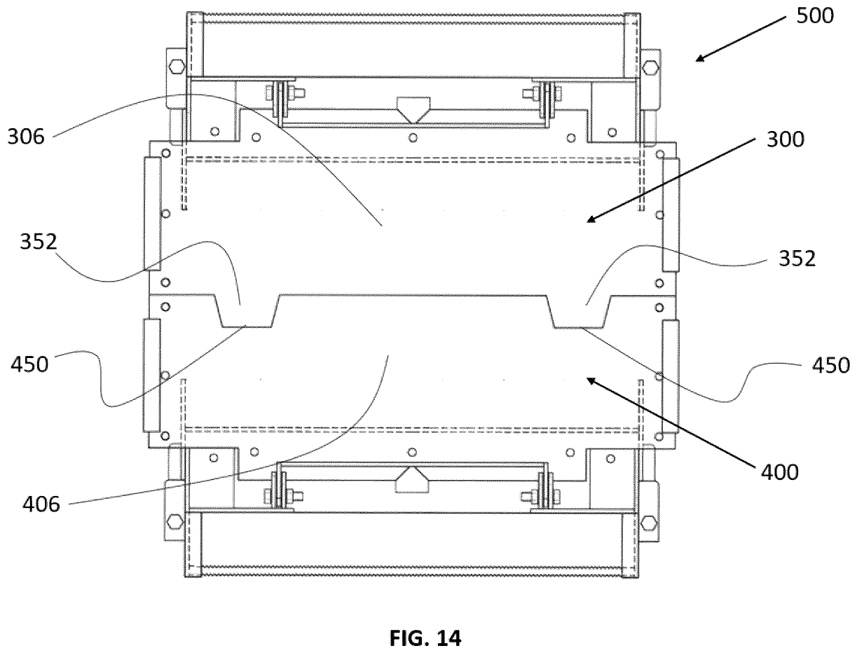

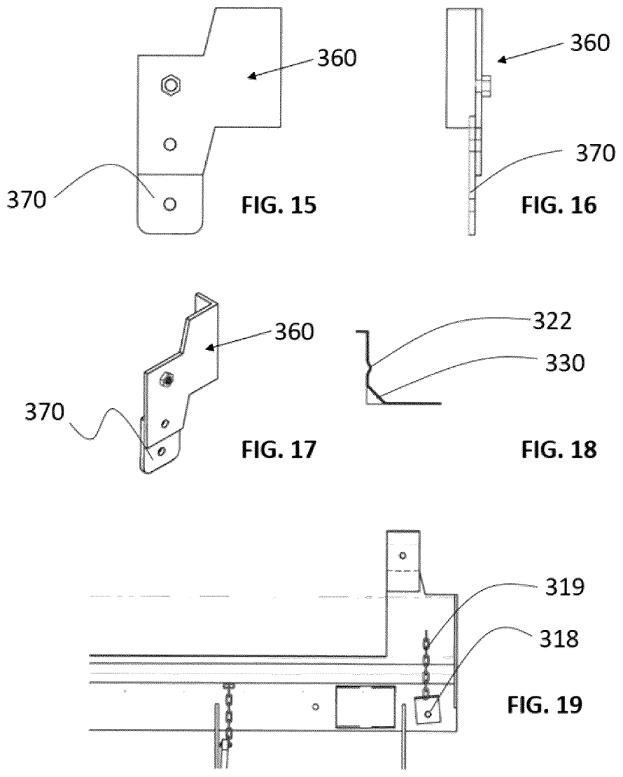

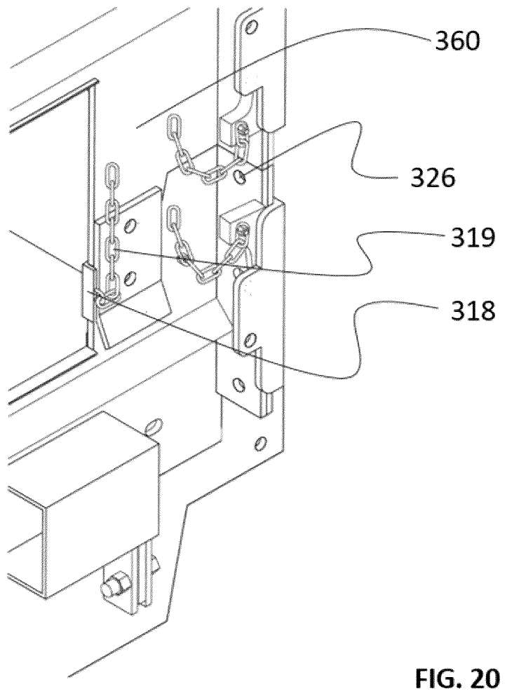

Referring to FIGS. 5 to 20, a mold 500 for manufacturing a concrete formwork module 100 as above described is shown. The mold 500 comprises a top section 300 and a bottom 400 section. The top section 300 is adapted to manufacture the first concrete layer 10 of a concrete formwork module 100 whereas the bottom section 400 is adapted to manufacture the fourth concrete layer 40 of the same concrete formwork module 100. The top 300 and bottom 400 sections of the mold 500 each have a substantially rectangular geometry defined by a bottom surface (301, 401) and four side walls (302, 304, 306, 308, 402, 404, 406 and 408) creating a mold cavity (310, 410). The mold cavities (310, 410) are adapted to receive and hold poured concrete.

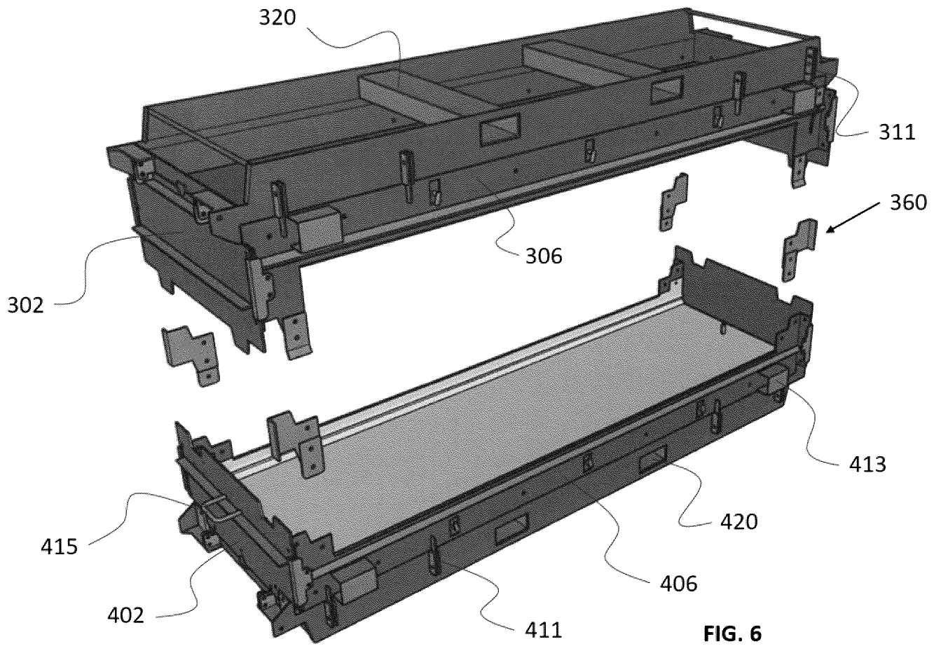

Referring to FIGS. 5 and 6, a preferred embodiment of the mold 500 for manufacturing a concrete formwork module 100 as described above is illustrated. In this embodiment, the mold 500 comprises a top section 300 and a bottom section 400. The top section 300 and the bottom section 400 each comprise a bottom surface (301, 401) and four removable side doors (302, 304, 306, 308, 402, 404, 406 and 408). The four removable side doors (302, 304, 306, 308, 402, 404, 406 and 408) of each of the top section 300 and bottom section 400 may be secured or unsecured using hinges 309 securing the side doors to the base of the mold 500. The longitudinal side doors (306, 308, 406 and 408) may further comprise dowels 311 to securely close the mold 500. It may be appreciated that any means other than hinges 309 or dowels 311 may be used to secure or unsecure the side doors. The top section 300 and the bottom section 400 may further comprise protection stops (313, 413). The side doors (302, 304, 402 and 404) may further comprise handles (315, 415) to help with the operation of the mold.

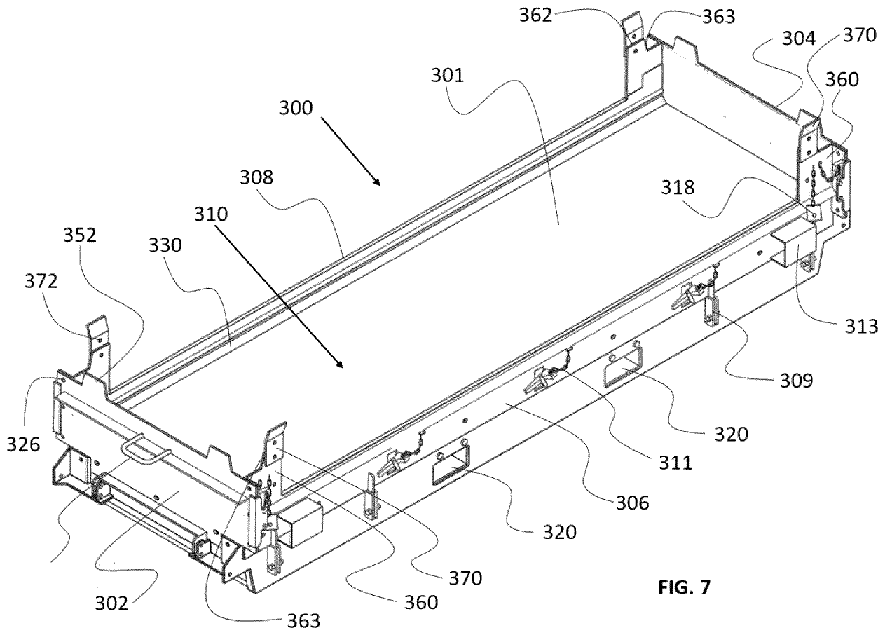

Referring to FIG. 7, the top section of the mold 300 is disposed in a loading and drying position. In this position, the top section of the mold 300 may receive concrete and may house said concrete until it is dry enough to generally retain the mold shape would it be rotated over or removed from the mold section 300. The top mold section 300 may comprise tabs (not shown) located at the ridge of the longitudinal side walls (306, 308). The tabs are embodied as rectangular panels having a height sufficient enough to help align the insulating layer 20 with the first concrete layer 10. The geometry, size, location and quantity of tabs may vary in other embodiments.

In another embodiment of the invention where the transversal side walls (302, 304, 402, 404) are of a lesser height than the illustrated embodiment, the transversal side walls (302, 304) may each comprise an abutment stand. The abutment stands are configured to abut against correlating abutment of the bottom mold section 400 when the two section are joined to form the complete mold 500.

Referring now to FIGS. 7, 19 and 21, the top section 300 may further comprise a removable guide 318 to help maintain the superposition of the assemble mold 500. The removable guide 318 may be a substantially square plaque comprising a perpendicularly bent edge that fits behind the extensions 360 and 370. The removable guide 318 may be attached to the extensions 360 using a chain 319. Understandably, the removable guide 318 may have any other shape or size.

In another embodiment of the invention, the top section 300 may be elevated from the ground, or any supporting structure, at a certain distance due to legs (not shown) located on its bottom surface 301 and extending downwardly. The distance between the bottom surface 301 of the top section 300 and the ground may allow the disposition of handling means 320 disposed on the bottom surface 301 of the top section 300. The handling means 320 are embodied as substantially hollow beams covering the width, or at least part of, of the top mold section 300. The handling means 320 are used to manipulate the top mold section 300 with specialized equipment, such as with the forks of a forklift. Accordingly, the top mold section 300 may be elevated, displaced and rotated with specialized equipment having those capabilities.

Referring now to FIGS. 7, 8 and 18, the top mold section 300 may comprise protrusions or ridges 322 on any of the side walls (302, 304, 306, 308). In the embodiment shown, the protrusions or ridges 322 are located on the longitudinal side walls (306, 308) and may either protrude toward the mold cavity 310 or away from the mold cavity 310. Understandably, the protrusions or ridges 322 will create the aligning means 60 of the concrete formwork module 100 when concrete is poured in the mold 300. Thus, their geometry, size, location and quantity may vary in other embodiments. The top mold section 300 may further comprise discharge openings (not shown) on the bottom surface 301 for evacuating concrete overfill.

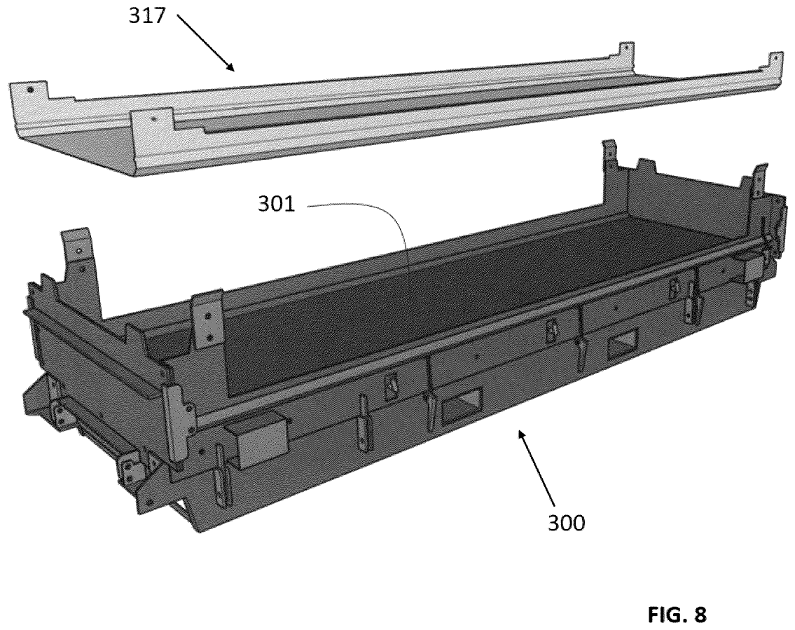

Referring now to FIGS. 8, 12 and 13 the top section 300 and the bottom section 400 may further comprise a protective sheet (317, 417) of solid material laid on top of the surfaces (301, 401). The protective sheet (317, 417) may be made of stainless steel. The protective sheet 417 of the bottom section 400 may further comprise a nut 418 and means to fix them to the surface 401 like for example, but not limited to a bolt or screw 419.

It may be appreciated that in order to remove dried concrete from the top mold section 300 without breaking or damaging said concrete, the longitudinal side walls (306, 308) may be partially unsecured from the mold 300, especially from the transversal side walls (302, 304). Fastening holes (not shown) may be located at corresponding locations on the longitudinal (306, 308) and transversal (302, 304) side walls in order to receive fasteners such as bolts. Once fasteners are removed from the fastening holes 326, the longitudinal side walls (306, 308) may be moved away from the cavity 310 to allow removal of the concrete dried in the cavity 310. Understandably, even if fasteners are removed, the longitudinal side walls (306, 308) may still be secured to the top mold section 300 through other means.

Referring now to FIG. 7 to 9 and 18, the top mold section 300 may comprise an edge 330 disposed between the bottom surface 301 and a longitudinal side wall (306 or 308). The edge's position may be angled at a value anywhere from the horizontal plane of the bottom surface 301 to the vertical plane of the longitudinal side wall (306 or 308). The edge 330 is embodied as a sheet of metal, such as steel or aluminum, and may create a corresponding edge 13, as seen in FIGS. 1 to 4, on the outer surface of the first concrete layer 10 of a concrete formwork module 100.

Now referring to FIGS. 10 to 12 and 21, the bottom mold section 400 is substantially similar to the top mold section 300 albeit some distinctive elements, such as follows. The bottom section 400 does not contain a removable guide similar to the removable guide 318 of the top section 300. Furthermore, as will be described in more detail in the following paragraphs, the bottom section 400 and the top section 300 comprise somewhat complementary geometries in the elements that allow them to fit to constitute the assemble mold 500. For example, the sides 302 and 402 have complementary geometries. Furthermore, in the embodiment in which the mold 500 comprises abutment stands (not shown), the abutment stands of the bottom mold section 400 may comprise alignment corners. The alignment corners are adapted to extend upwardly from the abutment stand surface in order to receive and guide the corresponding abutment stand of the top mold section 300 when combining the two sections to form the complete mold 500. For example, one side of a bottom mold may comprise an alignment corner comprising two perpendicular extrusions. Understandably, in other embodiments, alignment corners could also be found on the abutment stands of the top mold section 300. The person skilled in the art of molds may appreciate that any of the above-described features of the top mold section 300 may also be applied to the bottom mold section 400 and is therefore not limited herewith.

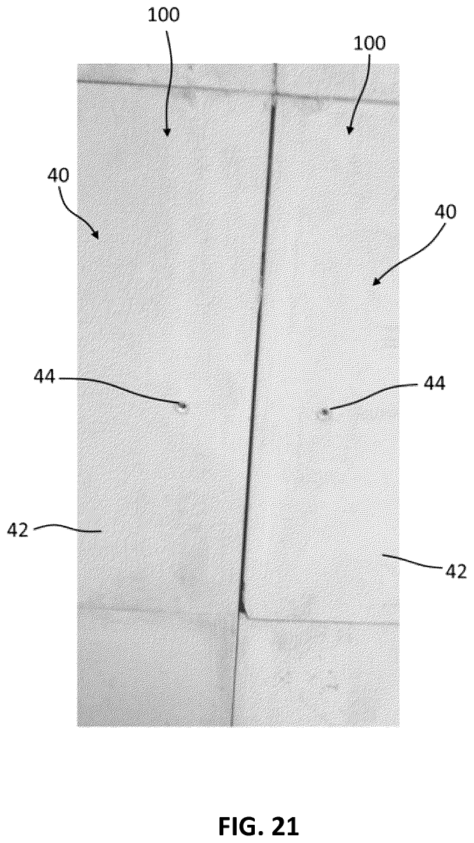

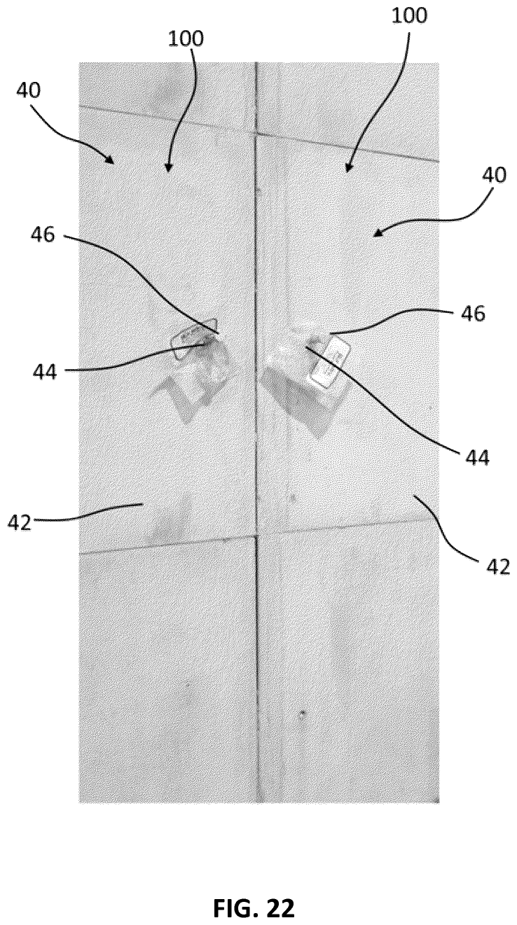

The top 300 or bottom 400 mold sections may further comprise fasteners, not shown, with the head facing the bottom surface (301, 401) of the mold section and the fastening body protruding upwardly. The fasteners may be covered by concrete poured in the cavity (310, 410) of the mold section and coincidentally create fastening holes 44 in the dried concrete 40, as may be seen in FIGS. 21 and 22. With the concrete formwork module 100 removed from the mold 500, the fasteners may be removed from the concrete 40, thus exposing the fastening holes 44 to be used by users of the building or structure formed by the concrete formwork modules 100. Accordingly, fasteners 46 may be installed be users in the fastening holes 44 when the concrete formwork module 100 is installed in a building or structure. The fastening holes 44 may thus preferably be located on the surface 42 of the concrete layer 40 facing inwardly of the building or structure, however they could also be located on the surface 12 facing outward of the building or structure.

Referring now to FIGS. 6 to 17, the top section 300 and the bottom section 400 may further comprise upwardly extending extensions (360, 460) over the ends of the longitudinal side walls (306, 308, 406 and 408). Because the transversal side walls (302, 304, 402 and 404) extend from the bottom surface (301, 401) of the mold sections (300, 400) at a substantial height, they may be configured to abut against the other transversal side walls (302, 304, 402 and 404) of the other mold section (300 or 400). To help guide the alignment of the top 300 and bottom 400 mold sections, a section may comprise notches 450 and the other section may comprise corresponding teeth 352, or tabs. The corresponding notches 450 and teeth 352 may therefore transversally align the top 300 and bottom 400 sections of the mold 500.

The extensions (360, 460) of the longitudinal side walls (306, 308, 406 and 408) may be located adjacent the transversal side walls (302, 304, 402 and 404) and may extend at a substantially similar height to the latter. Each of the extensions (360, 460) may comprise two elevations (362, 364, 462 and 464). The two elevations (362, 364, 462 and 464) may be connected by an angled surface (363, 463). For the extensions (360, 460) of either the bottom 400 or top 300 mold section, the highest elevation may be adjacent to the transversal side wall (302, 304, 402 and 404) and the lowest elevation may be closer to the center of the longitudinal side wall (306, 308, 406, 408). For the other of the two mold sections, the highest elevation may correlate with the lower elevation of the other mold section and the lowest elevation may correlate with the highest elevation of the other mold section. The corresponding extensions (360, 460) may therefore longitudinally align the top 300 and bottom 400 sections of the mold 500.

The extensions (360, 460) may further comprise securing tabs 370. One or both of the top 300 and bottom 400 sections may comprise the securing tabs 370 on their extensions (360, 460). In the embodiment shown, the securing tabs 370 are secured to a first extension 360 of a mold section 300 and extend toward the corresponding extension 460 of the other mold section 400. A fastening hole (372, 472) is disposed on the securing tab 370 and on the extension 460 of the opposite mold section 400. Accordingly, when the top 300 and bottom 400 mold sections are combined, the fastening hole 372 of the securing tabs 370 and of the corresponding extension 460 may align, thus allowing securing of the two mold sections (300, 400). The person skilled in the art may appreciate that because the fastening holes (372, 472) of the extensions and of the securing tabs are not covered by concrete, the two mold sections (300, 400) may easily be secured and unsecured with fewer risks of damaging the concrete.

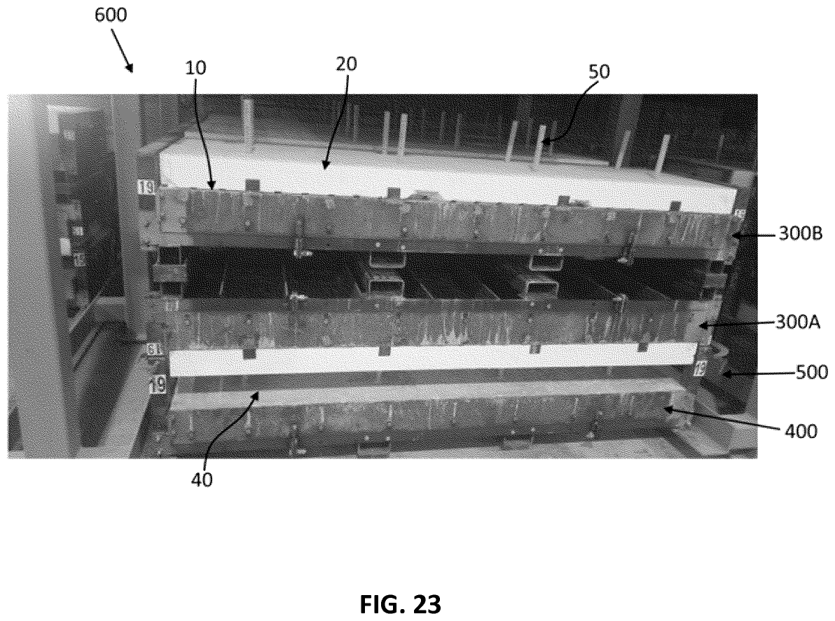

FIG. 23 shows an embodiment of a concrete formwork mold assembly 600 using the above-described molds and modules. The mold assembly 600 comprises three sections: a bottom section 400 and two top sections (300A, 300B). The bottom section 400 is usually configured to receive a layer of concrete, generally the fourth concrete layer 40 facing the inward of a building or structure. The two top sections (300A, 300B) are usually configured to receive a layer of concrete and a layer of insulating material, generally the first concrete layer 10 facing outward of the building or structure and the second insulating layer 20. It may be appreciated that the concrete layers (10, 40) do not exceed the height of the longitudinal side walls (306, 308, 406, 408) of the top (300A, 300B) and bottom 400 mold sections. The insulating layer 20 is layered over the first concrete layer 10 and is longitudinally and transversally secured by abutment stands and tabs. Connecting rods 50 are vertically placed through the concrete layer 10 and the insulating layer 20 of the top mold section 300A and through the concrete layer 40 of the bottom mold section 400. The distance between combined top 300A and bottom 400 mold sections is determined by the height of the abutment stands.

The person skilled in the art would appreciate that by having two top mold sections (300A and 300B), drying of a combined top and bottom mold section may substantially always be possible without significant downtime. Indeed, when concrete is poured in a top mold section 300, a certain period of time is required for the concrete to dry before the top mold section 300 may be rotated around to avoid spilling and deformation of the concrete's mold shape. Hence, with only a top 300 section and a bottom 400 section in an assembly, a waiting time would be required when pouring concrete in a newly freed up top mold section 300. However, by having at least a second top mold section 300B with concrete already drying up when the first top mold section 300A is combined with the bottom mold section 400, the second top mold section 300B may almost instantly be combined with the bottom section 400 once the previously combined mold 500 is freed up. Because the concrete poured in the bottom mold section 400 is not rotated around, it may be combined with a top mold section 300 almost instantly after pouring said concrete. Understandably, more than two top mold sections 300 may be comprised in a mold assembly 600, nevertheless two top sections (300A, 300B) should be sufficient to optimally reduce manufacturing downtimes.

A method of manufacturing and installing a concrete formwork module 100, such as the above-described module, will now be described. The concrete formwork modules 100 are manufactured in a factory comprising above-described concrete formwork molds 500 and mold assemblies 600. Once manufactured, the manufactured concrete formwork modules 100 may be displaced with ease, with conventional machinery, due to the air layer 30 not being filled with reinforced concrete yet, to the building or structure site for stacking with or placing next to other concrete formwork modules 100 to create a concrete formwork section 200. The concrete formwork section 200 may form a wall, or any other part of a building or structure wherein concrete formworks may be used. As detailed above, because the concrete formwork modules 100 dimensions are generally precise due to the use of a mold 500, and because of the various elements allowing alignment of layers of the modules 100, there the need to use conventional retaining braces when installing the concrete formwork modules 100 is reduced. The use of scaffoldings is further significantly reduced, if not eliminated, because there is no need to drill finished surfaces on the interior 42 and/or exterior 12 surfaces of the concrete formwork modules 100 due to the interior 42 and/or exterior 12 surfaces of the modules 100 already comprising a finished surface.

In the factory, a concrete formwork mold assembly 600 is provided. The mold assembly 600 comprises at least two top mold sections (300A, 300B) and a bottom mold section 400. Each of the top (300A, 300B) and bottom 400 mold sections have their mold cavity (310, 410) opening up upwardly. Longitudinal side walls (306, 308, 406 and 408) of the top (300A, 300B) and bottom 400 mold sections may be secured by fastening means to transversal side walls (302, 304, 402, 404) of the section to obtain a desired mold shape. Concrete, usually architectural concrete, is poured in the mold cavity 310 of a first top mold section 300. The poured concrete should not overfill the mold cavities (310, 410) of neither the top (300A, 300B) or bottom 400 mold sections. Discharge openings 324 may evacuate excess concrete. An insulating layer 20 may then be installed over the poured concrete of the top mold section 300. The installation of the insulating layer 20 may be guided by tabs 312 and abutment stands (314, 316) so that it aligns precisely with the concrete layer 10. Before installing the insulating layer 20, holes may be pierced in the insulating layer 20 to receive connecting rods 50. Accordingly, once the insulating layer 20 is layered over the concrete layer 10, connecting rods 50 may be pushed through the pierced holes of the insulating layer 20 and through part of the concrete's layer 10 height.

Following installation of the concrete layer 10, the insulating layer 20 and the connecting rods 50, the top mold section 300 may rest with the cavity mold 310 facing upwardly for a predetermined drying period of time. The predetermined drying period of time is configured to allow sufficient drying of the concrete to not spill or deform if said concrete contained mold would be turned around. Once the predetermined drying period of time is over, the top mold section 300 may be manipulated by its handling means 320. A specialized forklift may insert forks into the handling means 320 consisting of the hollow beams. The specialized forklift may raise the top mold section 300 from the ground or any other structural support and may rotate the top mold section 300 at a 180 degree angle, hence until the mold cavity 310 is facing downwardly.

Before combining the top mold section 300 with the bottom mold section 400, but after pouring concrete in the top mold section 300, concrete may be poured in the bottom mold section 400. The pouring of concrete in the bottom mold section 400 at a predetermined time before combining with the top mold section 300 allows the insertion of the connecting rods 50 through the concrete of the bottom mold section 400 because said concrete is not too hard yet. Following pouring of concrete in the bottom mold section 400, and before said concrete is too hard to insert the connecting rods 50, the specialized forklit may displace the top mold section 300 over the bottom mold section 400. The top 300 and bottom 400 mold sections may thus be combined by lowering the top mold section 300, raising the bottom mold section 400, or a combination of both. The alignment of the top 300 and bottom 400 mold sections may be assisted by the alignment corners 440 or by notches 450 and teeths 352 and extensions (360, 460) of side walls of the molds. Securing tabs 370 may be fastened to secure the two mold sections (300, 400) together.

The combined top 300 and bottom 400 sections may be left combined for a given period of time until the concrete of both mold sections has set enough for removal from the mold 500. For example, the top 300 and bottom 400 sections of the mold 500 may be combined for approximately fourteen hours before removal. Understandably, the quality and type of concrete used may affect the setting time and is therefore not limited herewith. Removal of the concrete formwork module 100 from the combined mold 500 may comprise unfastening of the longitudinal side walls (306, 308, 406, 408) from the transversal side walls (302, 304, 402, 404) and removal of the top 300 and/or bottom 400 sections of the mold 500 with the handling means 320 by specialized machinery. During drying of the concrete in the combined mold 500, concrete may be poured in the second top mold section 300B of the assembly 600. Accordingly, once the concrete formwork module 100 is removed from the combined mold 500, the bottom mold section 400 may almost instantly be filled with concrete again and the second top mold section 300B may be combined with the bottom mold section 400. It may therefore be appreciated that operational downtimes may be significantly reduced, if not neglected, due to the premptive drying of concrete in a top mold section 300B when another top mold section 300A is combined with the bottom mold section 400. The method may further comprise cleaning of the top 300 and bottom 400 mold sections between fillings.

A method of assembling a concrete formwork section 200, such as the above-described section, is further provided. The method may comprise displacing two or more concrete formwork modules 100 as above-described to a building or structure site. With machinery, a first of the at least two concrete formwork modules 100 may be placed at a desired location. A second of the at least two concrete formwork modules 100 may then be placed adjacent to the first concrete formwork module 100, either on the sides or over the latter. The second concrete formwork module 100 may be abutted against the first module 100 so that each of their respective layers are aligned with one another. Aligning means 60 located on each respective concrete formwork module 100 may be used to improve the alignment precision. For example, rounded protrusions 62 and/or concave cavities 64 of a concrete formwork module 100 may match with correlating rounded protrusions 62 and/or concave cavities 64 of the other concrete formwork module 100. The alignment and abutment steps may be completed for as many concrete formwork modules 100 that are desired in the concrete formwork section 200. Reinforced concrete 32 may be poured in the air layer 30 of the concrete formwork modules 100 over a partly or fully assembled concrete formwork section 200. The reinforced concrete 32 may thus be poured from the top of a single or a plurality of assembled concrete formwork modules 100. The method may also comprise fastening fasteners 46 in fastening holes 44 located on the exterior 12 and/or interior 42 surfaces of the concrete layers (10, 40) of a concrete formwork module 100.

The concrete formwork modules 100 may be used for creating wall panel sections 200 in a plurality of different applications. For example, the concrete formworks modules 100 may be used in industrial buildings such as warehouses or factories, in residential buildings, in agricultural buildings such as barns, in retaining walls for retaining ground and in building or structures foundations. Understandably, the concrete formworks modules 100 may be used in various other applications and are not limited to walls.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1. A concrete formwork mold apparatus, comprising:
a top mold section having a mold cavity adapted for receiving poured concrete;
a bottom mold section having a mold cavity adapted for receiving poured concrete;
wherein each of the top and bottom mold sections comprises a substantially rectangular geometry defined by a bottom surface and four side walls creating a mold cavity.

2. The apparatus of claim 1, wherein the top mold section further comprises four removable side doors secured by hinges to the base of the mold.

3. The apparatus of claim 2, wherein the top mold section's removable side doors include dowels for securely closing the mold.

4. The apparatus of claim 1, wherein at least one of the top and bottom mold sections further comprises protection stops.

5. The apparatus of claim 1, wherein the top and bottom mold sections include removable guides to aid in maintaining the superposition of the assembled mold.

6. The apparatus of claim 1, wherein at least one of the top and bottom mold sections includes means for elevation from the ground.

7. The apparatus of claim 1, wherein the top mold section comprises protrusions or ridges on at least one of the side walls.

8. The apparatus of claim 1, further comprising a protective sheet of solid material laid on top of the surfaces of at least one of the top and bottom mold sections.

9. The apparatus of claim 1, wherein the top mold section includes an edge disposed between the bottom surface and a longitudinal side wall.

10. An assembly of concrete formwork molds, comprising at least two top mold sections and a bottom mold section configured to receive concrete, wherein the top mold sections are configured to receive concrete and an insulating material, and said assembly is used to manufacture concrete formwork modules.

11. A method of manufacturing a concrete formwork module, comprising:
providing a mold assembly comprising top and bottom mold sections;
pouring concrete into the top mold section;
installing an insulating layer over the concrete in the top mold section;
inserting connecting rods through the insulating layer;
allowing the concrete to dry with the mold cavity facing upward;
combining the top mold section with the bottom mold section after pouring concrete in the bottom mold section;
allowing the combined mold sections to dry.

12. The method of claim 11, further comprising cleaning the top and bottom mold sections between uses.

13. The method of claim 11, wherein the insulating layer is pierced to create holes before installing it over the concrete.

14. The method of claim 11, wherein the combined mold sections are left for a specified period of time to allow the concrete to set.

15. A method of assembling a concrete formwork section, comprising:
displacing two or more concrete formwork modules to a building or structure site;
placing a first concrete formwork module at a desired location;
placing a second concrete formwork module adjacent to the first concrete formwork module;
aligning the layers of the first and second concrete formwork modules using alignment means;
pouring reinforced concrete in the air layer between the assembled modules;
installing fasteners in holes located on the concrete modules'surfaces.

16. The method of claim 15, wherein the alignment means comprise rounded protrusions and concave cavities on the concrete formwork modules.

17. The method of claim 15, further comprising transporting the manufactured concrete formwork modules to the construction site.

18. The method of claim 15, wherein the concrete formwork modules are used to create a wall or part of a building.

19. The method of claim 15, wherein the concrete formwork modules are used for various applications, including industrial buildings, residential buildings, agricultural buildings, retaining walls, and building foundations.

20. The method of claim 15, wherein the concrete formwork modules are stacked or placed next to each other to create a concrete formwork section for a variety of applications.
